(19) United States
(12) Patent Application Publication
(10) Pub. No.: US 2017/0088045 A1
(43) Pub. Date: Mar. 30, 2017

(54) EXTERNAL VEHICLE WARNING SYSTEM AND METHOD

(71) Applicant: GM GLOBAL TECHNOLOGY OPERATIONS LLC, Detroit, MI (US)

(72) Inventor: Bradley M. Bezzina, Dearborn Heights, MI (US)

(73) Assignee: GM GLOBAL TECHNOLOGY OPERATIONS LLC, Detroit, MI (US)

(21) Appl. No.: 14/870,919

(22) Filed: Sep. 30, 2015

(51) Int. Cl. B60Q 5/00; G01S 15/02; G01S 17/02; G01S 13/02

(52) U.S. Cl. CPC B60Q 5/005; G01S 13/02; G01S 15/02; G01S 17/02

(57) ABSTRACT

A method of operating a vehicle includes driving the vehicle in a direction of travel along a route. An object detection system of the vehicle senses an object disposed on the route and in the direction of travel of the vehicle. When the vehicle is within a pre-defined distance or travel time of the object, a warning system of the vehicle is automatically engaged by the object detection system to alert the object to the presence of the vehicle as the vehicle approaches the object.

### TECHNICAL FIELD

The disclosure generally relates to a method of operating a vehicle, and to a vehicle having an object detection and warning system.

### BACKGROUND

Some modern vehicles are equipped with object detection systems that sense objects in the path of a vehicle and notify the driver of the vehicle of the object, and/or initiate a vehicular response to avoid contacting the object.

### SUMMARY

A method of operating a vehicle is provided. The method includes sensing an object in a position that is likely to interest a travel route of the vehicle, with an object detection system. A warning system of the vehicle is automatically engaged with the object detection system to alert the object to the presence of the vehicle as the vehicle approaches the object.

A vehicle is also provided. The vehicle includes at least one proximity sensor that is operable to sense data related to an object disposed in a direction of travel of the vehicle as the vehicle moves along a route. The vehicle further includes a warning system that is operable to emit a signal external to the vehicle. An object detection system is coupled to the at least one proximity sensor and the warning system. The object detection system includes a vehicle controller having a processor, and tangible, non-transitory memory on which are recorded computer-executable instructions, including an external warning module. The external warning module is operable to receive data from the at least one proximity sensor on the vehicle, and identify the object disposed on the route and in the direction of travel of the vehicle from the data received from the at least one proximity sensor. The external warning module then determines if the object and the vehicle may contact each other if each continue along a current route at a current speed, and classifies the identified object into one of a plurality of different object classifications. If the external warning module determines that the object and the vehicle may contact each other, the external warning module selects a preferred warning scheme based on the object classification of the identified object, and communicates a control signal to the warning system to engage the warning system, and execute the preferred warning scheme to alert the object to the presence of the vehicle as the vehicle approaches the object.

Accordingly, the object detection system senses and identifies an object in the path of the vehicle, and signals the warning system to emit a signal to notify the object. Accordingly, the object may be alerted to the oncoming vehicle, providing the object time to move out of the path of the vehicle, and avoid contact with the vehicle.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view showing a vehicle approaching an object in a roadway.

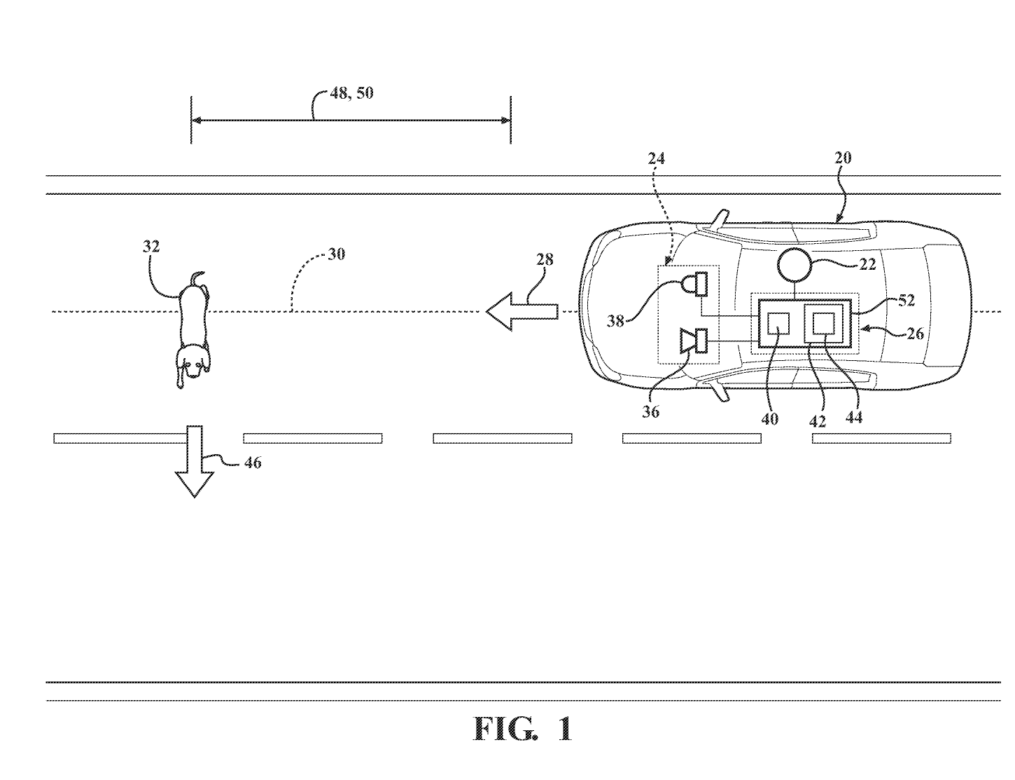

FIG. 2 is a schematic plan view showing the vehicle emitting a warning signal to alert the object of the approach of the vehicle.

### DETAILED DESCRIPTION

Those having ordinary skill in the art will recognize that terms such as “front,” “back,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a vehicle is generally shown at 20. The vehicle 20 may include, but is not limited to, an automobile, truck, train, motorcycle, boat, etc., and may be configured for on-road and/or off-road operation.

The vehicle 20 includes at least one proximity sensor 22, a warning system 24, and an object detection system 26. The proximity sensors(s) 22 may include, but are not limited to, a camera, a short range radar system, a long range radar system, a lidar system, or an ultrasonic system. The proximity sensors(s) 22 are operable to sense data related to an object 32 disposed in a direction of travel 28 of the vehicle 20 as the vehicle 20 moves along a route 30. Accordingly, the proximity sensors(s) 22 may include any device that is capable of sensing data related to the detection or identification of an object 32 relative to the direction of travel 28 of the vehicle 20. The proximity sensors(s) 22 communicate the sensed data to the object detection system 26. The proximity sensors 22 may be placed at any location of the vehicle 20 to sense objects 32 in any of a forward direction, rearward direction, left lateral direction and/or right lateral direction of the vehicle 20.

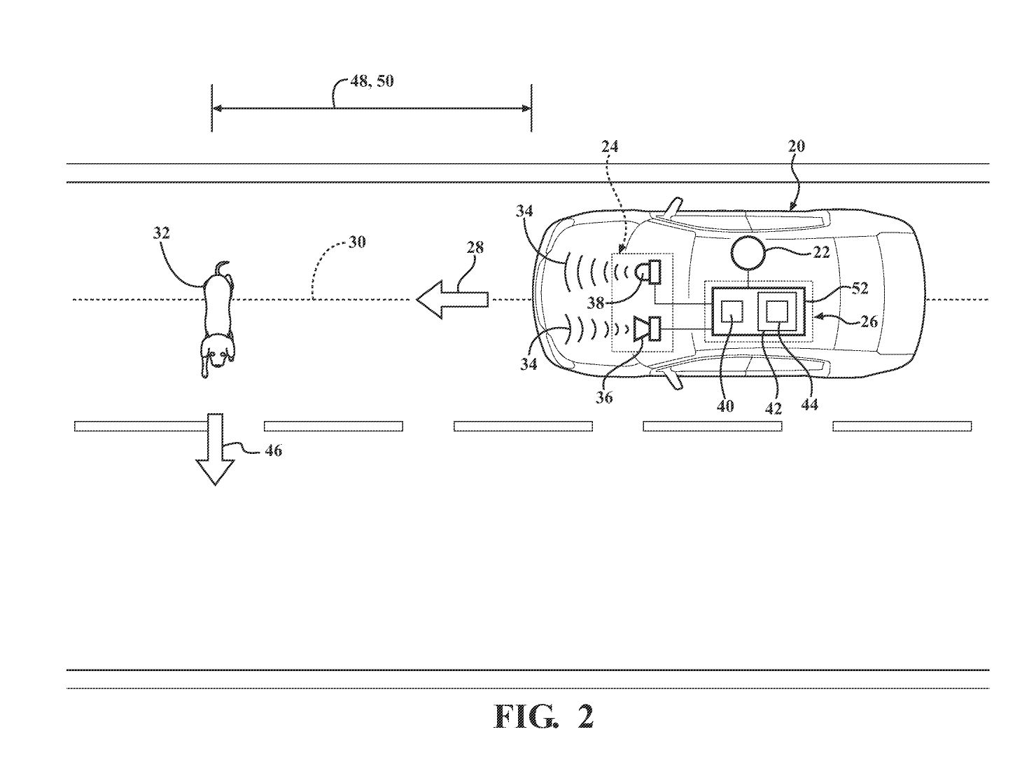

The warning system 24 is operable to emit a warning signal 34 (shown in FIG. 2) external to the vehicle 20. The warning system 24 may include, but is not limited, to an audio system 36 operable to emit an audio signal external to the vehicle 20, or a visual system 38 operable to emit a visual signal external to the vehicle 20. For example, the audio system 36 may include a horn of the vehicle 20. Alternatively, the audio system 36 may include a speaker positioned to emit sound away from the vehicle 20. The visual system 38 may include, but is not limited to a light of the vehicle 20, such as a front headlight of an automobile. Alternatively, the vehicle 20 may be equipped with one or more dedicated light producing devices capable of emitting light away from the vehicle 20, such as a strobe light or flashing beacon. The warning system 24 is controlled by the object detection system 26, and operates to emit the warning signal 34 in response to a control signal from the object detection system 26.

The object detection system 26 is coupled to and in communication with the proximity sensors(s) 22 and the warning system 24. As noted above, the object detection system 26 receives data from the proximity sensors(s) 22, and communicates a control signal to the warning system 24 to engage or disengage the warning system 24. The object detection system 26 includes a vehicle controller 52. The vehicle controller 52 may be referred to by many names known to those skilled in the art, such as a control module, computer, controller, etc. The vehicle controller 52 includes a processor 40, and tangible, non-transitory memory 42 on which are recorded computer-executable instructions, including an external warning module 44. The external warning module 44 is operable to execute the steps of a method of controlling the vehicle 20, described in greater detail below.

The vehicle controller 52 controls the operation of the proximity sensors(s) 22 and the warning system 24. The vehicle controller 52 may include a computer and/or processor 40, and include all software, hardware, memory 42, algorithms, connections, sensors, etc., necessary to manage and control the operation of the proximity sensors(s) 22, the warning system 24, and execute the external warning module 44. As such, the method of controlling the vehicle 20 described below may be embodied as the external warning module 44 operable on the vehicle controller 52. It should be appreciated that the vehicle controller 52 may include any device capable of analyzing data from various sensors, comparing data, making the necessary decisions required to the steps of the external warning module 44, and executing the required tasks necessary to control the operation of the warning system 24.

The vehicle controller 52 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 42 may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

As noted above, the external warning module 44 executes the method of controlling the vehicle 20, when the vehicle 20 is being driven in the direction of travel 28 along the route 30. The direction of travel 28 may include a forward direction, a rearward direction, a leftward lateral direction, or a rightward lateral direction, relative to a longitudinal axis of the vehicle 20. For example, if the vehicle 20 is moving forward, then the direction of travel 28 is the forward direction, whereas if the vehicle 20 is sliding sideways to the left, the direction of travel 28 would be to the leftward lateral direction. Accordingly, the direction of travel 28 of the vehicle 20 may include any direction relative to the longitudinal axis of the vehicle 20. The route 30 and the direction of travel 28 may be determined by any suitable means, including vehicle accelerometers, a GPS system, etc.

As the vehicle 20 moves along its route 30 in its direction of travel 28, the proximity sensors(s) 22 continuously sense data related to the detection and/or identification of the object 32 that lies in the route 30 of the vehicle 20, in the direction of travel 28 of the vehicle 20. Additionally, the object detection system 26 continuously senses and/or determines a speed of the vehicle 20 in the direction of travel 28 on the route 30 of the vehicle 20, or otherwise receives the speed of the vehicle 20 from some other vehicle 20 system. The object detection system 26 uses the data from the proximity sensors(s) 22 to sense and/or determine if the object 32 is in the route 30 and in the direction of travel 28 of the vehicle 20. The object 32 may include, but is not limited to, a human pedestrian, an animal such as a dog, deer, etc., or another vehicle 20.

The object detection system 26 identifies the object 32. Identifying the sensed object 32 may include not only detecting the object 32, but may also include classifying the sensed object 32 into one of a plurality of different object classifications. The different object classifications may include, but are not limited to, an animal object classification, a human object classification, or a vehicular object classification. The object detection system 26 may classify the object 32 based on the sensed data from the proximity sensors(s) 22, and specific algorithms stored in the memory 42 of the vehicle controller 52 and executable to recognize and identify various objects 32.

The object detection system 26 may further detect and/or otherwise determine a direction of movement 46 of the object 32, relative to the forward direction of travel 28 on the route 30 of the vehicle 20, and a speed that the object 32 is moving. For example, the object detection system 26 may determine that the object 32 is classified as a vehicular object 32 moving in the same direction of travel 28 on the same route 30 as the vehicle 20. Alternatively, the object detection system 26 may determine that the object 32 is classified as an animal object 32, moving in a transverse direction relative to the direction of travel 28 of the vehicle 20, such as may occur when a deer crosses a roadway.

The object detection system 26 may compare the direction of movement 46 and speed of the object 32, to the direction of travel 28 and speed of the vehicle 20, to identify or determine a potential contact between the object 32 and the vehicle 20. If the object detection system 26 determines that a potential contact is unlikely, based on the current position of the object 32 and/or vehicle 20, or based on the current direction of movement 46 and speed of the object 32 and/or vehicle 20, then the object detection system 26 may decide not to engage or otherwise signal the warning system 24. However, if the object detection system 26 determines that the object 32 and the vehicle 20 may contact each other if each continue along their respective current route 30 at their respective current speed, then the object detection system 26 may continue the process of engaging the warning system 24.

If the object detection system 26 determines that the object 32 and the vehicle 20 may contact each other, then the object detection system 26 may select a preferred warning scheme based on the object classification of the identified object 32, and/or based on the direction of movement 46 of the object 32. The object detection system 26 may include only a single warning scheme. Alternatively, the object detection system 26 may include several different warnings schemes, each configured to optimize communication with the specific object classification, and may alternatively be configured to optimize communication based on the direction of movement 46 of the object 32.

The different warning schemes may include, for example, a visual only warning scheme, an audio only warning scheme, or a combination of a visual and audio warning scheme. Furthermore, the different warning schemes may include only a single level of intensity, or the different warning schemes may include variable levels of intensity, whereby the intensity of the warning signal 34 increases as the vehicle 20 nears the object 32. For example, an audio warning signal 34 may increase in volume as the vehicle 20 nears the object 32, or a visual warning signal 34 may increase in brightness, or may increase a flash rate as the vehicle 20 nears the object 32. The warning schemes may be dependent upon the specific classification of the object 32. For example, if the object 32 is classified as an animal object 32, it may be determined that animal objects 32 generally respond more actively to a loud audio warning signal 34 by running away from the audio warning signal 34, and may respond more passively or “freeze’ in response to a visual warning signal 34, e.g., a bright light. In such a case, the warning scheme may be defined to optimize the response of the target, by using only an audio warning signal 34, such as shown in FIG. 2.

As shown in FIG. 2, once the warning scheme is selected, the object detection system 26 may then automatically engage the warning system 24 to emit the warning signal 34 to an exterior of the vehicle 20, and towards the object 32. The purpose of engaging the warning system 24 and emitting the warning signal 34 is to alert the object 32 to the presence of the vehicle 20 as the vehicle 20 approaches the object 32, thereby allowing the object 32 time to move out of the way of the oncoming vehicle 20 and avoid contact with the vehicle 20. The object detection system 26 engages the warning system 24 by communicating a control signal to the warning system 24, thereby engaging the warning system 24 and executing the preferred warning scheme.

The object detection system 26 may engage the warning system 24 as soon as the object detection system 26 identifies the object 32, or alternatively, may engage the object detection system 26 when the vehicle 20 moves to within a pre-defined distance 48 of the object 32, or the vehicle 20 is within a pre-defined time period 50 of contacting the object 32, at the current speed of the vehicle 20. In order to determine when to engage the warning system 24, the object detection system 26 continuously calculates an estimated period of time until the vehicle 20 contacts the object 32 as the vehicle 20 approaches the object 32, and/or continuously calculates an estimated distance between the vehicle 20 and the object 32. The object detection system 26 may use the sensed speed of the vehicle 20, and the data from the proximity sensors(s) 22, including a direction of travel 28 and speed of the object 32, to calculate the estimated period of time until the vehicle 20 and the object 32 contact each other, and/or the distance between the vehicle 20 and the object 32.

As shown in FIG. 2, the object detection system 26 may automatically engage the warning system 24 when the vehicle 20 travels to within the pre-defined distance 48 of the object 32. The pre-defined distance 48 may include a single value, or may vary based on a speed of the vehicle 20. For example, the pre-defined distance 48 may increase as the speed of the vehicle 20 increases, thereby providing a minimum amount of time/distance for the object 32 to react to the warning signal 34. Alternatively, the object detection system 26 may automatically engage the warning system 24 when the object detection system 26 determines that an estimated period of time until the vehicle 20 contacts the object 32 is equal to or less than the pre-defined time period 50. The pre-defined time period 50 may include a specific time period, or may vary based on the speed of the vehicle 20. For example, the pre-defined time period 50 may increase as the speed of the vehicle 20 increases, thereby providing a minimum amount of time/distance between for the object 32 to react to the warning system 24.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of operating a vehicle, the method comprising:
sensing an object in a position likely to intersect a travel route of the vehicle with an object detection system of the vehicle; and
automatically engaging a warning system of the vehicle with the object detection system to alert the object to the presence of the vehicle as the vehicle approaches the object.

2. The method set forth in claim 1 wherein automatically engaging the warning system is further defined as automatically engaging the warning system when the vehicle travels to within a pre-defined distance of the object.

3. The method set forth in claim 2 wherein the pre-defined distance varies with a speed of the vehicle.

4. The method set forth in claim 1 wherein automatically engaging the warning system is further defined as automatically engaging the warning system when the object detection system determines that an estimated period of time until the vehicle contacts the object is equal to or less than a pre-defined time period.

5. The method set forth in claim 4 wherein the pre-defined time period varies with a speed of the vehicle.

6. The method set forth in claim 1 further comprising identifying the sensed object.

7. The method set forth in claim 6 wherein identifying the sensed object includes classifying the sensed object into one of a plurality of different object classifications, wherein the object classifications include at least one of a human object, an animal object, or a vehicular object.

8. The method set forth in claim 7 wherein automatically engaging the warning system includes selecting a preferred warning scheme based on the object classification of the identified object.

9. The method set forth in claim 1 further comprising detecting a direction of movement of the object relative to the travel route of the vehicle.

10. The method set forth in claim 9 wherein automatically engaging the warning system includes selecting a preferred warning scheme based on the determined direction of movement of the vehicle.

11. The method set forth in claim 9 further comprising comparing the direction of movement of the object to the direction of travel of the vehicle, with the object detection system, to identify a potential contact between the object and the vehicle.

12. The method set forth in claim 11 further comprising continuously calculating an estimated period of time until the vehicle contacts the object as the vehicle approaches the object, when the object detection system identifies a potential contact between the object and the vehicle.

13. The method set forth in claim 1 further comprising sensing a speed of the vehicle in the direction of travel on the route of the vehicle.

14. The method set forth in claim 1 wherein the object detection system includes a vehicle controller having a processor and tangible, non-transitory memory on which are recorded computer-executable instructions, including an external warning module operable to:
receive data from at least one proximity sensor on the vehicle;
identify the object disposed on the route and in the direction of travel of the vehicle from the data received from the at least one proximity sensor;
classify the identified object into one of a plurality of different object classifications;
select a preferred warning scheme based on the object classification of the identified object; and
engage the warning system to execute the preferred warning scheme.

15. The method set forth in claim 1 wherein the vehicle includes at least one proximity sensor including one of a camera, a short range radar system, a long range radar system, a lidar system, or an ultrasonic system.

16. The method set forth in claim 1 wherein the warning system of the vehicle includes at least one of an audio system operable to emit an audio signal external to the vehicle, or a visual system operable to emit a visual signal external to the vehicle.

17. The method set forth in claim 1 wherein automatically engaging the warning system includes executing a warning scheme that incrementally increases in intensity as the vehicle nears the object.

18. A vehicle comprising:
at least one proximity sensor operable to sense data related to an object disposed in a direction of travel of the vehicle as the vehicle moves along a route;
a warning system operable to emit a signal external to the vehicle;
an object detection system coupled to the at least one proximity sensor and the warning system, the object detection system including:
a vehicle controller having a processor and tangible, non-transitory memory on which are recorded computer-executable instructions, including an external warning module operable to:
receive data from the at least one proximity sensor on the vehicle;
identify the object disposed on the route and in the direction of travel of the vehicle from the data received from the at least one proximity sensor;
determine that the object and the vehicle may contact each other if each continue along a current route at a current speed;
classify the identified object into one of a plurality of different object classifications;
select a preferred warning scheme based on the object classification of the identified object; and
communicate a control signal to the warning system to engage the warning system and execute the preferred warning scheme to alert the object to the presence of the vehicle as the vehicle approaches the object.

19. The vehicle set forth in claim 18 wherein the at least one proximity sensor includes one of a camera, a short range radar system, a long range radar system, a lidar system, or an ultrasonic system.

20. The vehicle set forth in claim 18 wherein the warning system includes at least one of an audio system operable to emit audio signal external to the vehicle, or a visual system operable to emit a visual signal external to the vehicle.
